(19) United States
(12) Patent Application Publication
(10) Pub. No.: US 2026/0225376 A1
(43) Pub. Date: Aug. 6, 2026

(54) PRINTING DEVICE, PRINTING METHOD, AND PRINTING SYSTEM

(71) Applicant: BROTHER KOGYO KABUSHIKI KAISHA, Nagoya (JP)

(72) Inventors: Yuji IIDA, Chita (JP); Yoshihisa KAYANAKA, Kuwana (JP); Yuki KOBAYASHI, Nagoya (JP)

(21) Appl. No.: 19/461,274

(22) Filed: Jan. 27, 2026

(30) Foreign Application Priority Data
Jan. 31, 2025 (JP) 2025-015148

(51) Int. Cl. B41J 2/21; B41J 2/165; B41J 3/407; B41J 11/06; B41J 25/00; D06P 5/30; G06K 15/02; G06K 15/10

(52) U.S. Cl. CPC B41J 2/2103; B41J 2/16535; B41J 3/4078; B41J 11/06; B41J 25/001; D06P 5/30; G06K 15/102; G06K 15/1843

(57) ABSTRACT

A printing device includes: a color head ejects a color ink; a base head ejects a base ink; a first platen supports a first portion, the first portion is one of a neck portion and a body portion located apart from the neck portion provided on a print medium; a second platen supports a second portion, the second portion is the other one of the neck portion and the body portion; and a control device. The control device executes first processing of ejecting the color ink to the first portion supported by the first platen, second processing of ejecting the base ink to the second portion supported by the second platen, and third processing of ejecting the color ink to the second portion supported by the second platen. At least a part of the second processing is executed during execution of the first processing.

### REFERENCE TO RELATED APPLICATIONS

This application claims priority from Japanese Patent Application No. 2025-015148 filed on Jan. 31, 2025. The entire contents of the priority application are incorporated herein by reference.

### BACKGROUND ART

In a related art, there is known a printing device that executes printing on a neck tag and a body part of a T-shirt in a state in which the neck tag is supported by a first platen and the body part is supported by a second platen.

However, in the above-described printing device in the related art, it is conceivable to execute printing on the body part after printing on the neck tag is completed. In this case, for example, base printing on the body part is executed after color printing on the neck tag is completed. For this reason, printing time is long.

### SUMMARY

An object of the present disclosure is to provide a printing device, a printing method, and a printing system that can shorten printing time.

According to the present disclosure, there is provided a printing device including a color head configured to eject a color ink, a base head configured to eject a base ink, a first platen configured to support a first portion, the first portion being one of a neck portion and a body portion located apart from the neck portion provided on a print medium, a second platen configured to support a second portion, the second portion being the other one of the neck portion and the body portion, and a control device. The control device is configured to execute first processing of ejecting the color ink from the color head to the first portion supported by the first platen, second processing of ejecting the base ink from the base head to the second portion supported by the second platen, and third processing of ejecting the color ink from the color head to the second portion supported by the second platen. At least a part of the second processing is executed during execution of the first processing.

According to the present disclosure, at least a part of the second processing is executed during the execution of the first processing, and thus printing time can be shortened as compared with a case where the second processing is executed after the execution of the first processing.

### BRIEF DESCRIPTION OF DRAWINGS

FIG. 1 shows a schematic configuration of a printing system including a printing device and an image processing device that is an external device according to an embodiment.

FIG. 2 is a block diagram showing a configuration of a control system of the printing system in FIG. 1.

FIG. 3 shows a T-shirt that is an example of a print medium.

FIG. 4 is a perspective view showing a configuration of a platen mechanism.

FIG. 5 is a perspective view showing a mode in which the T-shirt is supported by a first platen and a second platen in a state in which a frame body of the platen mechanism is in a non-pressing position.

FIG. 6 is a perspective view showing a mode in which the frame body is in a pressing position in a state in which the T-shirt is supported by the first platen and the second platen.

FIG. 7 is a flowchart showing a flow of a printing process of the printing device.

FIG. 8 shows an example of execution timing of the printing process of the printing device.

FIG. 9 is a table showing an example of print resolutions in processing for a neck portion and print resolutions in processing for a body portion.

FIG. 10 shows a moving range of a carriage during execution of ejection processing to the neck portion.

FIG. 11A shows an example of execution timing of the printing process of the printing device, and FIG. 11B shows an example of execution timing of the printing process of the printing device.

### DESCRIPTION

Hereinafter, an embodiment of the present disclosure will be described with reference to the drawings. The embodiment described below is merely one embodiment of the present disclosure. Accordingly, the present disclosure is not limited to the following embodiment, and the embodiment can be added, deleted, or modified without departing from the scope of the present disclosure. In the following description, the same or corresponding elements in all the drawings are denoted by the same reference signs, and redundant description thereof is omitted unless otherwise noted.

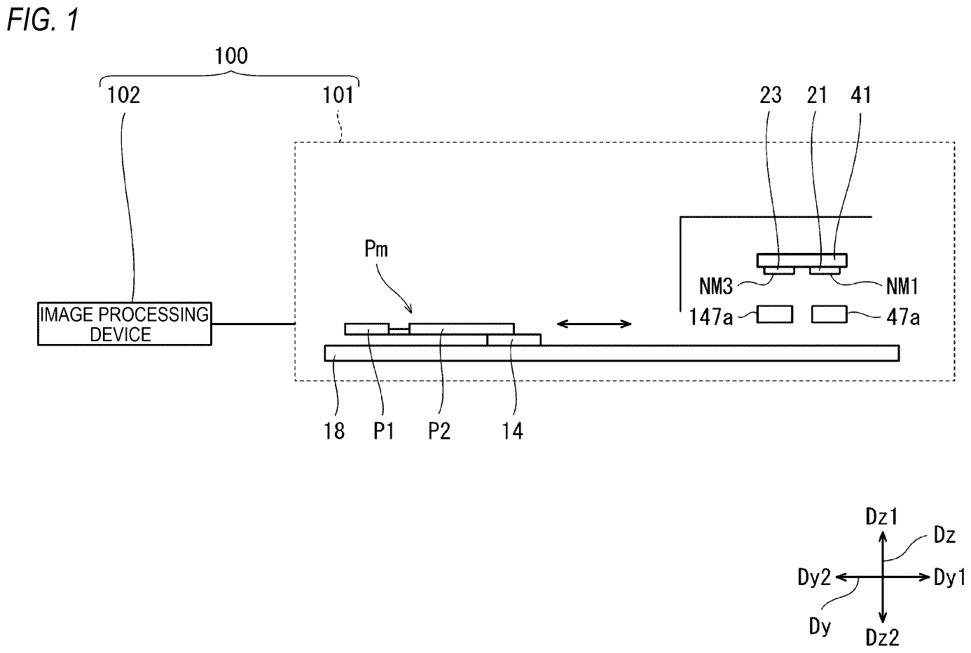

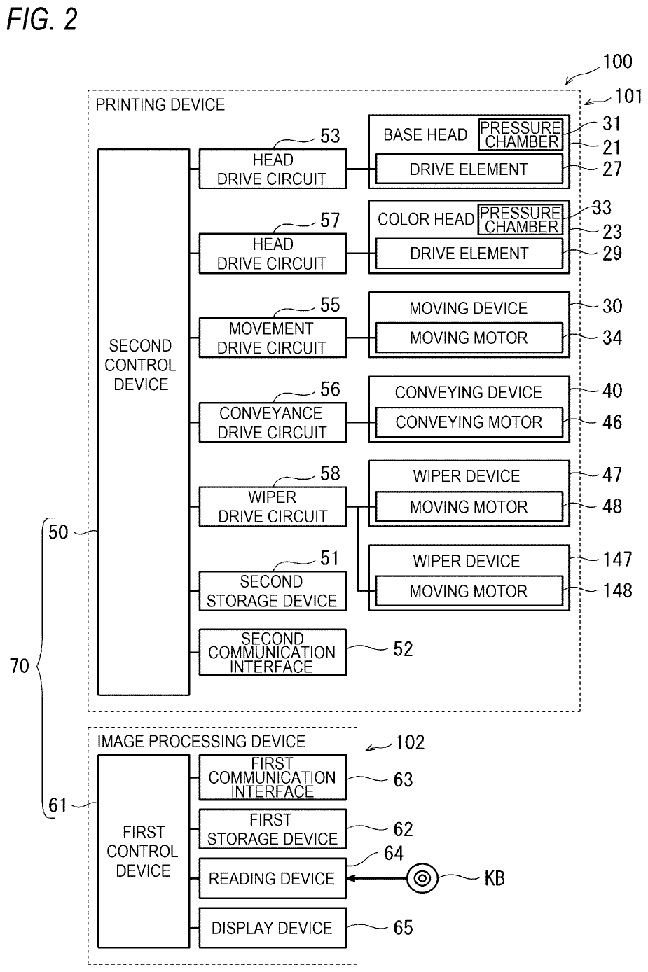

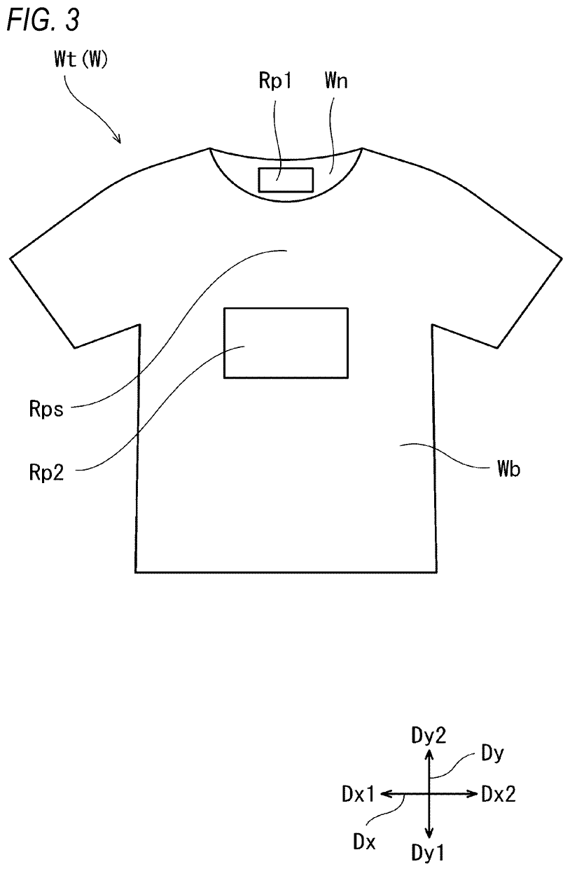

FIG. 1 shows a schematic configuration of a printing system 100 including a printing device 101 and an image processing device 102 according to an embodiment. FIG. 2 is a block diagram showing a configuration of a control system of the printing system 100 in FIG. 1. FIG. 3 shows a T-shirt Wt that is an example of a print medium W.

In FIGS. 1 and 3, FIG. 4 to be described later, and the like, directions orthogonal to one another are a first direction Dy, a second direction Dx, and a third direction Dz. In the present embodiment, for example, the first direction Dy is a conveying direction of the print medium W, the second direction Dx is a moving direction of a carriage 41 to be described later, and the third direction Dz is an upper-lower direction. In the following description, Dx is referred to as the moving direction, Dy is referred to as the conveying direction, and Dz is referred to as the upper-lower direction. One direction of the conveying direction Dy is Dy1, and the direction opposite to the direction Dy1 is Dy2. In the present embodiment, the print medium W is conveyed, for example, in the direction Dy2 of the conveying direction Dy during printing. One direction of the moving direction Dx is denoted by Dx1, and the direction opposite to the direction Dx1 is denoted by Dx2. An upward direction of the upper-lower direction Dz is Dz1, and a downward direction is Dz2. However, the above directions are examples and are not limited.

As shown in FIGS. 1 and 2, the printing system 100 according to the present embodiment includes the printing device 101 and the image processing device 102. The printing device 101 and the image processing device 102 are communicably connected to each other in a wireless or wired manner such as a network. An example of a communication standard in a case where the printing device 101 and the image processing device 102 are communicably connected in a wireless manner includes Wi-Fi. An example of a communication standard in a case where the printing device 101 and the image processing device 102 are communicably connected in a wired manner includes Ethernet. The image processing device 102 corresponds to a print data generator of the present disclosure.

The image processing device 102 is, for example, a personal computer. The image processing device 102 creates print data from image data of a print image, which is an image to be printed on the print medium W by the printing device 101, and transmits the created print data to the printing device 101 in a wireless or wired manner. The image processing device 102 creates first part print data for executing printing at a first resolution, which is a prescribed image resolution, on a neck portion Wn to be described later of the T-shirt Wt, and creates second part print data for executing printing at a second resolution, which is an image resolution different from the first resolution, on a body portion Wb to be described later of the T-shirt Wt. Then, the image processing device 102 creates print data by integrating the created first part print data and second part print data at a higher image resolution of the first resolution and the second resolution. For example, the image processing device 102 creates the first part print data for executing printing at 900 dpi and the second part print data for executing printing at 1200 dpi, and creates print data obtained by integrating the first part print data and the second part print data at 1200 dpi. The image processing device 102 may be assembled in the printing device 101.

The printing device 101 is, for example, a serial head type inkjet printer. The printing device 101 alternately repeats pass processing of ejecting ink droplets while moving an inkjet head in the moving direction Dx and conveying processing of conveying the print medium W in the conveying direction Dy based on the print data received from the image processing device 102. Accordingly, a prescribed image is printed on the print medium W.

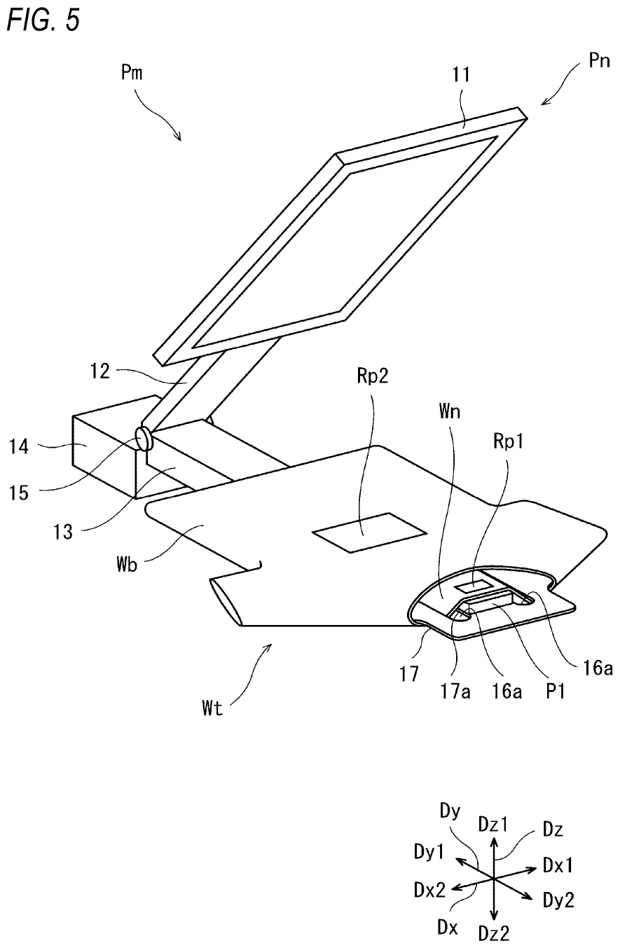

Here, as shown in FIG. 3, the T-shirt Wt is exemplified as the print medium W in the present embodiment. In the following description, the print medium W is the T-shirt Wt. The T-shirt Wt includes the body portion Wb and the neck portion Wn. The body portion Wb is, for example, a front body of the T-shirt Wt. The body portion Wb is located apart from the neck portion Wn. For example, the body portion Wb is located apart from the neck portion Wn across an intermediate region Rps. The intermediate region Rps may be, for example, a plain region or a non-plain region. The neck portion Wn is a portion near an opening through which a neck of a user passes when the user wears the T-shirt Wt, and is a portion of a surface of a back body on a front body side. The neck portion Wn is a portion that does not overlap the front body in a state of FIG. 3, or a portion that overlaps the front body in the state of FIG. 3 but does not overlap the front body in a state of FIG. 5 to be described later.

The printing device 101 executes printing in a prescribed region Rp1 in the neck portion Wn and a prescribed region Rp2 in the body portion Wb. For example, the region Rp1 has a dimension in the moving direction Dx smaller than a dimension of the region Rp2 in the moving direction Dx, and has a dimension in the conveying direction Dy smaller than a dimension of the region Rp2 in the conveying direction Dy. For example, a neck tag may be attached to the region Rp1 of the neck portion Wn, and in this case, the printing device 101 executes printing on the neck tag. In the present embodiment, when the neck portion Wn corresponds to a first portion of the present disclosure, the body portion Wb corresponds to a second portion of the present disclosure, and when the neck portion Wn corresponds to the second portion of the present disclosure, the body portion Wb corresponds to the first portion of the present disclosure.

The printing device 101 includes a base head 21, a color head 23, a platen mechanism Pm, a moving device 30, a conveying device 40, and wiper devices 47, 147. The base head 21 and the color head 23 are, for example, inkjet heads.

The base head 21 and the color head 23 print an image on the T-shirt Wt with prescribed ink droplets based on print data. The base head 21 and the color head 23 are arranged side by side in the conveying direction Dy. For example, the base head 21 and the color head 23 are arranged in an order of the color head 23 and the base head 21 in the direction Dy1 of the conveying direction Dy. The base head 21 has a nozzle surface NM1 in which nozzle holes of nozzles, which are not shown, are opened. The color head 23 has a nozzle surface NM3 in which nozzle holes, which are not shown, are opened. An arrangement of the base head 21 and the color head 23 is an example and may be changed as appropriate. The nozzle surface NM3 corresponds to a first nozzle surface of the present disclosure, and the nozzle surface NM1 corresponds to a second nozzle surface of the present disclosure.

The base head 21 executes printing on the T-shirt Wt with white ink that is an example of a base ink. Accordingly, a base is formed on the T-shirt Wt. The color head 23 executes printing on the T-shirt Wt with a color ink. Examples of the color ink include cyan ink, magenta ink, yellow ink, and black ink.

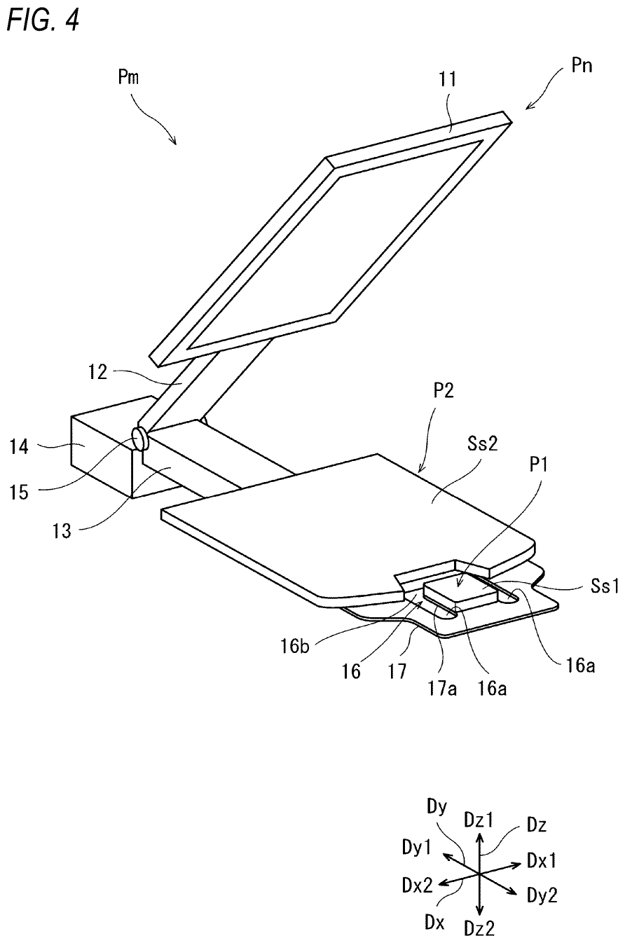

The platen mechanism Pm includes a first platen P1, a second platen P2, and a platen support portion 14 in FIG. 4 to be described later. The first platen P1 supports the first portion that is one of the neck portion Wn and the body portion Wb of the T-shirt Wt. The second platen P2 supports the second portion that is the other one of the neck portion Wn and the body portion Wb of the T-shirt Wt. For example, the first platen P1 supports the neck portion Wn, and the second platen P2 supports the body portion Wb. The first platen P1 and the second platen P2 reciprocate in the conveying direction Dy. Accordingly, the neck portion Wn supported by the first platen P1 and the body portion Wb supported by the second platen P2 are conveyed in the conveying direction Dy. A detailed configuration of the platen mechanism Pm will be described later.

The moving device 30 includes the carriage 41, a pair of guide rails, neither of which are shown, and a moving motor 34. The guide rails extend in the moving direction Dx. The carriage 41 supports the base head 21 and the color head 23. The carriage 41 is supported by the guide rails to reciprocate in the moving direction Dx. When the moving motor 34 rotates, an endless belt, which is not shown, coupled to the moving motor 34 operates, and the carriage 41 attached to the endless belt reciprocates on the guide rails in the moving direction Dx. Accordingly, the base head 21 and the color head 23 reciprocate in the moving direction Dx.

The conveying device 40 includes, for example, the platen support portion 14, a conveying motor 46, and a guide rail 18. The first platen P1 and the second platen P2 are supported by the platen support portion 14 as shown in FIG. 1 and FIG. 4 to be described later. The platen support portion 14 is not limited to being provided on a direction Dy1 side relative to the first platen P1 shown in FIG. 4. The platen support portion 14 may be provided, for example, on a direction Dz2 side relative to the first platen P1. Although a case where an arm 12 is provided will be described later, the arm 12 may not be provided. In this case, a frame body 11 may not be provided, or may be disposed on the first platen and the second platen on which the T-shirt Wt is supported by a user. Further, an arm 13 may not be provided. For example, the platen support portion 14 may include a cylinder, and the platen support portion may support a platen by the platen being inserted into the cylinder. The first platen P1 and the second platen P2 may be attachable to and detachable from the platen support portion 14. Accordingly, when the first platen P1 and the second platen P2 having different sizes are provided, printing can be executed by the first platen P1 and the second platen P2 having desired sizes.

When the conveying motor 46 starts driving, the platen support portion 14 is conveyed in the conveying direction Dy along the guide rail 18 via, for example, a belt drive mechanism. Accordingly, the first platen P1 and the second platen P2 are conveyed in the conveying direction Dy, and the T-shirt Wt is conveyed in the conveying direction Dy.

The wiper device 47 includes a wiper 47a in FIG. 1, a moving mechanism, and a moving motor 48. The moving mechanism includes, for example, a ball screw or a rack and pinion, and is connected to the moving motor 48 and supports the wiper 47a. In a state in which the nozzle surface NM1 is disposed in a position of facing the wiper 47a, the wiper 47a moves in the upward direction Dz1 via the moving mechanism and comes into contact with the nozzle surface NM1 by the moving motor 48 rotating. When the carriage 41 moves in the moving direction Dx in a state in which the wiper 47a is in contact with the nozzle surface NM1, wiping processing in which the nozzle surface NM1 is wiped by the wiper 47a is executed. Similarly to the wiper device 47, the wiper device 147 includes a wiper 147a, a moving mechanism, and a moving motor 148 in FIG. 1. Similarly to the wiper 47a, when the carriage 41 moves in the moving direction Dx in a state in which the wiper 147a is in contact with the nozzle surface NM3, wiping processing in which the nozzle surface NM3 is wiped by the wiper 147a is executed.

As shown in FIG. 2, the base head 21 is provided with a drive element 27 and a pressure chamber 31 for each nozzle 24. The color head 23 is provided with a drive element 29 and a pressure chamber 33 for each nozzle 26. The drive elements 27, 29 are piezoelectric elements or the like. When the drive element 27 of the base head 21 starts driving, ejection pressure for ejecting ink droplets of the white ink from corresponding nozzles is applied to the white ink in the pressure chamber 31. Accordingly, ink droplets of the white ink are ejected from the nozzles. An operation of the drive element 29 of the color head 23 is the same as an operation of the drive element 27 of the base head 21.

The printing device 101 includes a second control device 50. The printing device 101 further includes a second storage device 51, a second communication interface 52, a head drive circuit 53, a head drive circuit 57, a movement drive circuit 55, a conveyance drive circuit 56, and a wiper drive circuit 58, which are connected to the second control device 50. The second control device 50 corresponds to a control device of the present disclosure.

The second storage device 51 is a memory accessible from the second control device 50 and includes, for example, a RAM and a ROM. The RAM temporarily stores print data and various data during calculation of the second control device 50. The ROM stores various data and a printing program for executing various data processing.

The second control device 50 is implemented by a computer, and includes a processor such as a CPU or an integrated circuit such as an ASIC. The second control device 50 controls operations of components of the printing device 101 by executing the printing program while referring to data stored in the second storage device 51. The second control device 50 receives various data such as print data from the image processing device 102 via the second communication interface 52. The second control device 50 may be implemented by a single device, or may be configured such that a plurality of independent devices cooperate to control an operation of the printing device 101. Specifically, the second control device 50 may constitute a control device 70 in cooperation with a first control device 61 to be described later of the image processing device 102, and the control device 70 may control the operation of the printing device 101.

The head drive circuit 53 controls an operation of the drive element 27 based on an instruction from the second control device 50. In this case, the second control device 50 outputs a control signal for driving the drive element 27 to the head drive circuit 53, and the head drive circuit 53 generates a drive signal based on the control signal, and outputs the drive signal to the drive element 27. The drive element 27 applies prescribed ejection pressure to the white ink in the pressure chamber 31 at prescribed timing based on the drive signal. Accordingly, ink droplets of the white ink are ejected from nozzles of the base head 21. Similar to the first head drive circuit 53, the head drive circuit 57 controls an operation of the drive element 29 based on an instruction from the second control device 50. Accordingly, ink droplets of the color ink are ejected from nozzles of the color head 23.

The movement drive circuit 55 controls an operation of the moving motor 34 provided in the moving device 30 based on an instruction from the second control device 50. Accordingly, the carriage 41 reciprocates in the moving direction Dx. Therefore, the base head 21 and the color head 23 reciprocate in the moving direction Dx. The conveyance drive circuit 56 controls an operation of the conveying motor 46 of the conveying device 40 based on an instruction from the second control device 50. Accordingly, the first platen P1 and the second platen P2 intermittently or continuously convey the T-shirt Wt along the conveying direction Dy, and stop the T-shirt Wt in a prescribed position. The wiper drive circuit 58 controls an operation of the moving motor 48 of the wiper device 47 and an operation of the moving motor 148 of the wiper device 147 based on an instruction from the second control device 50. Accordingly, the moving mechanism of the wiper device 47 moves in the conveying direction Dy or the moving direction Dx, the wiper 47a of the wiper device 47 wipes the nozzle surface NM1, the moving mechanism of the wiper device 147 moves in the conveying direction Dy or the moving direction Dx, and the wiper 147a of the wiper device 147 wipes the nozzle surface NM3.

The image processing device 102 processes a print image to be printed by the printing device 101, and is, for example, a personal computer. The image processing device 102 includes the first control device 61 and a first storage device 62, a first communication interface 63, a reading device 64, and a display device 65, which are connected to the first control device 61. The image processing device 102 may be a smartphone, a tablet, and the like.

The first storage device 62 is a memory accessible from the first control device 61 and includes, for example, a RAM and a ROM. The RAM temporarily stores image data and various data during calculation of the first control device 61. The ROM stores various data and a printing program for executing various data processing. Examples of the image data include raster data indicating an image to be printed on the T-shirt Wt.

The first control device 61 is implemented by a computer, and includes a processor such as a CPU or an integrated circuit such as an ASIC. The first control device 61 controls the operation of the printing device 101 and an operation of the display device 65 by executing the printing program while referring to the data stored in the first storage device 62. The first control device 61 transmits various data such as print data to the printing device 101 via the first communication interface 63. The first control device 61 may be implemented by a single device, or may be configured such that a plurality of independent devices cooperate to control the operation of the image processing device 102.

The reading device 64 reads a printing program stored in a storage medium KB such as a CD-ROM or a USB flash memory. The read printing program is stored in the first storage device 62. Alternatively, the printing program may be downloaded via a prescribed communication network and stored in the first storage device 62. The display device 65 is a display and displays a print image or the like to be printed by the printing device 101 based on image data.

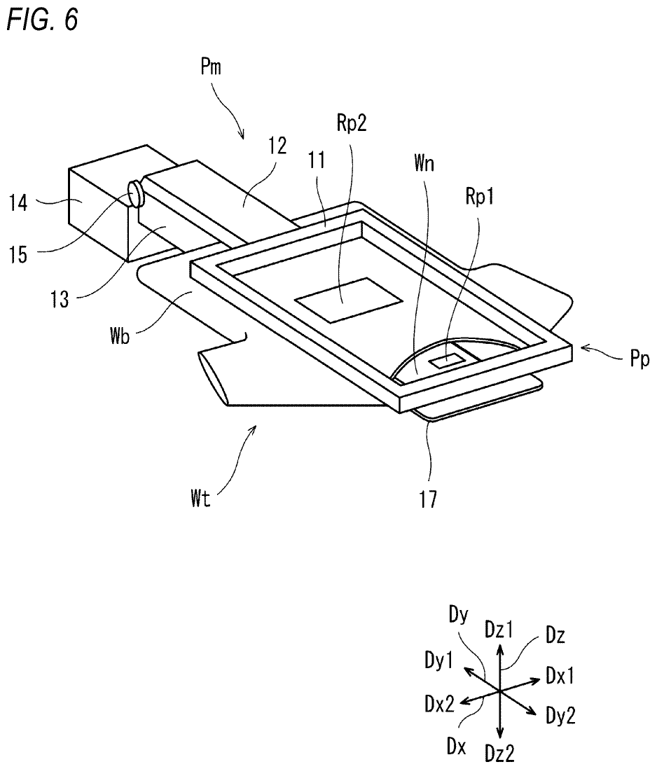

Next, the configuration of the platen mechanism Pm will be described in detail. FIG. 4 is a perspective view showing the configuration of the platen mechanism Pm. FIG. 5 is a perspective view showing a mode in which the T-shirt Wt is supported by the first platen P1 and the second platen P2 in a state in which the frame body 11 of the platen mechanism Pm is in a non-pressing position Pn. FIG. 6 is a perspective view showing a mode in which the frame body 11 is in a pressing position Pp in a state in which the T-shirt Wt is supported by the first platen P1 and the second platen P2.

As shown in FIG. 4, the platen mechanism Pm includes the first platen P1, the second platen P2, the frame body 11, the arms 12, 13, the platen support portion 14, a hinge 15, and a lower member 17.

The frame body 11 has a rectangular outer shape, for example. The frame body 11 is connected to a distal end of the arm 12. Accordingly, the frame body 11 is supported by the arm 12. A base end of the arm 12 is connected to a base end of the arm 13 via the hinge 15. Accordingly, the arm 12 pivots. Specifically, the arm 12 pivots between the non-pressing position Pn where the T-shirt Wt is not pressed by the frame body 11 as shown in FIGS. 4 and 5 and the pressing position Pp where the T-shirt Wt is pressed from above by the frame body 11 as shown in FIG. 6. As the arm 12 pivots, the frame body 11 pivots between the non-pressing position Pn and the pressing position Pp.

The second platen P2 is connected to a distal end of the arm 13. Accordingly, the arm 13 supports the second platen P2. The arm 13 extends in the conveying direction Dy. Accordingly, the second platen P2 extends in the conveying direction Dy. The platen support portion 14 supports the arm 13.

The lower member 17 is formed in, for example, a plate shape. The lower member 17 is fixed to a lower surface of the second platen P2. A distal end side part of the lower member 17, which is an end portion thereof on a direction Dy2 side, protrudes in the direction Dy2 from a distal end of the second platen P2. The lower member 17 is provided with a hole 16 running in the upper-lower direction Dz. The hole 16 is formed in, for example, a U shape, and thus has a pair of extending parts 16a, 16a extending in the conveying direction Dy. The lower member 17 includes a support portion 17a located between the one extending part 16a and the other extending part 16a of the hole 16 in the moving direction Dx. The shape of the hole 16 is not particularly limited.

The first platen P1 is formed in, for example, a substantially rectangular shape in a plan view. The first platen P1 is provided separately from the second platen P2 in the conveying direction Dy. The first platen P1 is supported by the support portion 17a of the lower member 17. Between the first platen P1 and the second platen P2 in the conveying direction Dy, an extending part 16b of the hole 16 extending in the moving direction Dx is disposed. The first platen P1 has a support surface Ss1 that supports the neck portion Wn of the T-shirt Wt. Specifically, the support surface Ss1 of the first platen P1 supports a back surface of the neck portion Wn from below. The support surface Ss1 of the first platen P1 has an area smaller than an area of a support surface Ss2 of the second platen P2 to be described later.

The second platen P2 is formed in, for example, a substantially rectangular shape in a plan view. The second platen P2 has the support surface Ss2 that supports the body portion Wb of the T-shirt Wt. Specifically, the support surface Ss2 of the second platen P2 supports the body portion Wb from below. The support surface Ss2 of the second platen P2 has an area larger than the area of the support surface Ss1 of the first platen P1. The support surface Ss1 in the upper-lower direction Dz has the same height as a height of the support surface Ss2 in the upper-lower direction Dz. The height of the support surface Ss1 and the height of the support surface Ss2 are not necessarily the same and may be substantially the same, and are considered to be the same in the present disclosure even when the heights are substantially the same.

When arranging the T-shirt Wt relative to the first platen P1 and the second platen P2 before printing is executed, an operator moves the T-shirt Wt from the direction Dy1 and passes the second platen P2 through the T-shirt Wt in a state in which the frame body 11 is arranged at the non-pressing position Pn as shown in FIG. 5. Accordingly, the body portion Wb of the T-shirt Wt is supported by the support surface Ss2. Then, in a state in which the body portion Wb of the T-shirt Wt is supported by the support surface Ss2, the operator passes the neck portion Wn located below the first platen P1 through the extending part 16b and the pair of extending parts 16a, 16a of the hole 16, and disposes the neck portion Wn on the first platen P1. Accordingly, the neck portion Wn is supported by the support surface Ss1.

After the body portion Wb is supported by the support surface Ss2 and the neck portion Wn is supported by the support surface Ss1 in this manner, the operator grips the frame body 11 and pivots the frame body 11 from the non-pressing position Pn to the pressing position Pp as shown in FIG. 6. Accordingly, the frame body 11 is disposed on the T-shirt Wt in a state in which the region Rp1 of the neck portion Wn and the region Rp2 of the body portion Wb are exposed. Thereafter, the T-shirt Wt is conveyed in the conveying direction Dy so that printing is executed by the base head 21 or the like.

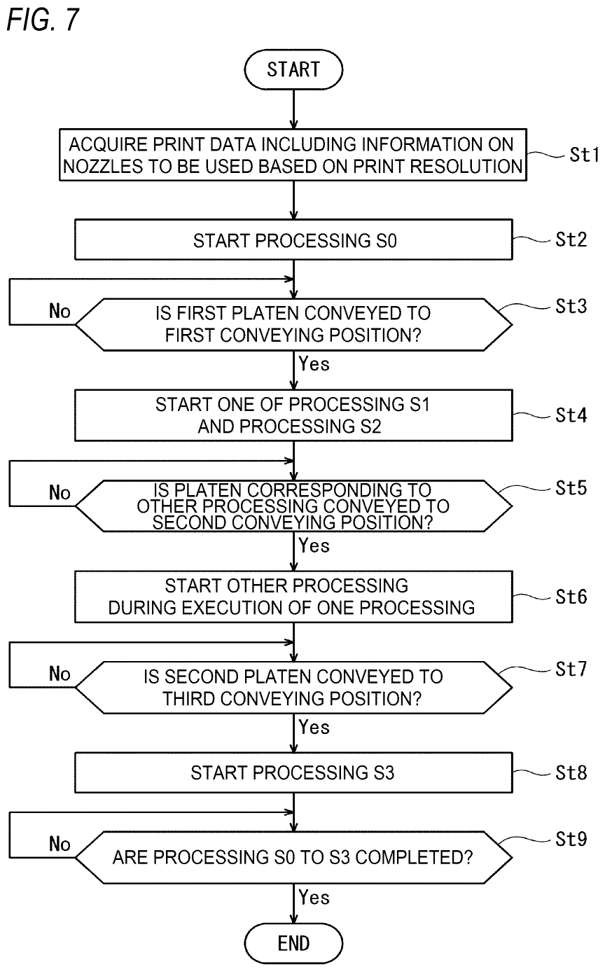

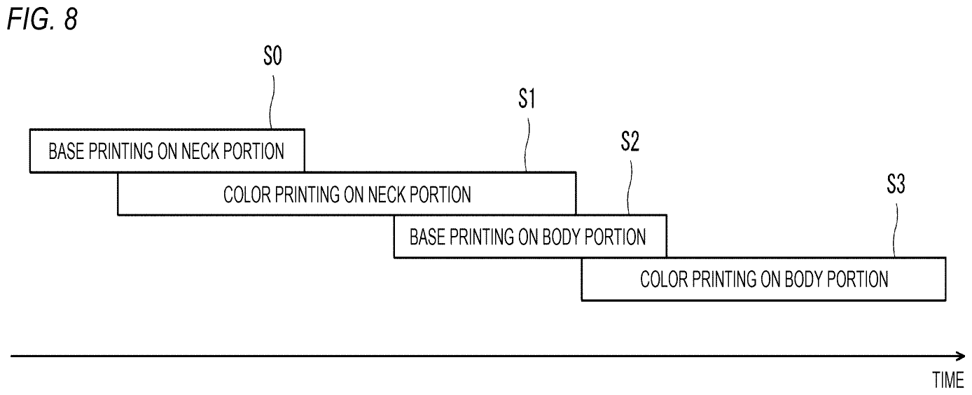

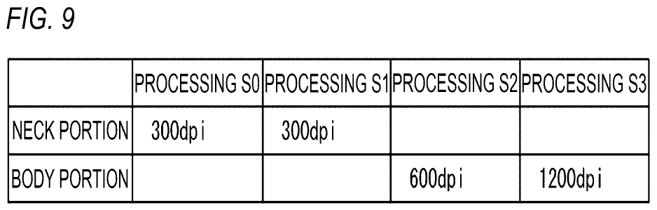

Next, a printing process of the printing device 101 will be described. FIG. 7 is a flowchart showing a flow of the printing process of the printing device 101. FIG. 8 shows an example of execution timing of the printing process of the printing device 101. FIG. 9 is a table showing an example of print resolutions in processing S0, S1 for the neck portion Wn and print resolutions in processing S2, S3 for the body portion Wb.

As shown in FIG. 7, when receiving a print instruction from the image processing device 102, the second control device 50 acquires, from the image processing device 102, print data including information on nozzles to be used that are nozzles to eject ink droplets based on a print resolution to be described later (step St1).

Next, as shown in FIGS. 7 and 8, the second control device 50 starts processing S0 (step St2). Processing S0 includes pass processing of ejecting white ink droplets from the base head 21 to the region Rp1 of the neck portion Wn while moving the base head 21 in the moving direction Dx, and conveying processing of conveying the neck portion Wn in the direction Dy2 of the conveying direction Dy. As shown in FIG. 9, the print resolution in processing S0 is, for example, 300 dpi. Processing S0 may be started when a button, which is not shown, provided in the printing device 101 is operated.

Subsequently, the second control device 50 determines whether the first platen P1 is conveyed to a first conveying position (step St3). The first conveying position is a position where a part of the region Rp1 of the neck portion Wn is disposed below the color head 23. When the first platen P1 is not conveyed to the first conveying position (No in step St3), the conveying continues.

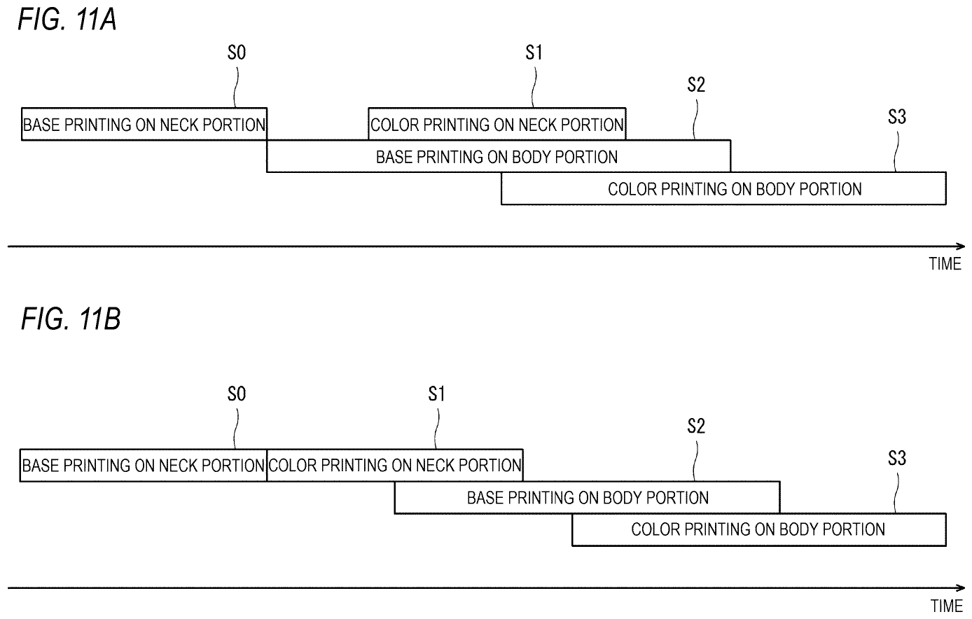

On the other hand, when the first platen P1 is conveyed to the first conveying position (Yes in step St3), the second control device 50 starts one of processing S1 and processing S2 (step St4). In this regard, in a case of a mode shown in FIG. 8 and FIG. 11B to be described later, the second control device 50 starts processing S1 as the one processing, and in a case of a mode shown in FIG. 11A to be described later, the second control device 50 starts processing S2 as the one processing.

Processing S1 includes pass processing of ejecting color ink droplets from the color head 23 to the region Rp1 of the neck portion Wn while moving the color head 23 in the moving direction Dx, and conveying processing of conveying the neck portion Wn in the direction Dy2 of the conveying direction Dy. Processing S2 includes pass processing of ejecting white ink droplets from the base head 21 to the region Rp2 of the body portion Wb while moving the base head 21 in the moving direction Dx, and conveying processing of conveying the body portion Wb in the direction Dy2 of the conveying direction Dy. Processing S1 corresponds to first processing of the present disclosure, and processing S2 corresponds to second processing of the present disclosure.

Here, the second control device 50 executes processing S1 and processing S2 such that a higher one of the print resolution in the conveying direction Dy in processing S1 and the print resolution in the conveying direction Dy in processing S2 is an integral multiple of a lower one. For example, as shown in FIG. 9, the print resolution in processing S1 is 300 dpi, and the print resolution in processing S2 is 600 dpi. In this case, based on the information on the nozzles to be used included in the print data, the second control device 50 reduces the number of nozzles to be used during printing corresponding to the lower print resolution by thinning out the nozzles at a prescribed interval in the moving direction Dx relative to the number of nozzles to be used during printing corresponding to the higher print resolution. The print resolution corresponds to a resolution of the present disclosure, and is a resolution of an image to be printed on the T-shirt Wt.

Next, the second control device 50 determines whether one of the first platen P1 and the second platen P2 which is the platen corresponding to the other processing of processing S1 and processing S2 is conveyed to a second conveying position (step St5). The second conveying position is a position where a part of the region Rp2 of the body portion Wb is disposed below the base head 21 when the other processing is processing S2, that is, when the above described one of the platens is the second platen P2. The second conveying position is a position where a part of the region Rp1 of the neck portion Wn is disposed below the color head 23 when the other processing is processing S1, that is, when the above described one of the platens is the first platen P1.

When neither of the platens is conveyed to the second conveying position (No in step St5), the conveying continues. On the other hand, when one of the platens is conveyed to the second conveying position (Yes in step St5), the second control device 50 starts the other processing during execution of the one processing (step St6). In this regard, in a case of the mode shown in FIG. 8 and FIG. 11B to be described later, the second control device 50 starts processing S2 as the other processing, and in a case of the mode shown in FIG. 11A to be described later, the second control device 50 starts processing S1 as the other processing.

Here, specific processing by the second control device 50 in step St6 is as follows. The second control device 50 divides the region Rp1, which is an ejection region in the neck portion Wn, into regions N1 to Nn corresponding to respective conveying steps in the conveying direction Dy, and ejects color ink droplets to a region Nx (1≤x≤n). In addition, the second control device 50 divides the region Rp2, which is an ejection region in the body portion Wb, into regions B1 to Bm corresponding to respective conveying steps in the conveying direction Dy, and ejects white ink droplets to a region By (1≤y≤m). A conveying step is processing of conveying the print medium W in the conveying direction Dy between one pass processing and a next pass processing. Then, when the color ink droplets are ejected to the region Nx and the region By is located below the base head 21, the second control device 50 ejects the white ink droplets to the region By at that time. Alternatively, when the white ink droplets are ejected to the region By and the region Nx is located below the color head 23, the second control device 50 ejects the color ink droplets to the region Nx at that time. The second control device 50 executes processing of step St4 and processing of step St8 to be described later in the same manner as processing of step St6.

The ejection of the color ink droplets to the region Nn in processing S1 and the ejection of the white ink droplets to the region Bm in processing S2 are preferably executed at the same timing. The ejection of the color ink droplets and the ejection of the white ink droplets may not be executed at the same timing, as long as the ejection of the color ink droplets to the neck portion Wn and the ejection of the white ink droplets to the body portion Wb are executed in one conveying step. In addition, the above-described processing by the second control device 50 may be applied not only when the first platen P1 and the second platen P2 are conveyed in the direction Dy2 of the conveying direction Dy during printing, but also when the first platen P1 and the second platen P2 are conveyed in the direction Dy1 together with the direction Dy2 during printing.

Next, the second control device 50 determines whether the second platen P2 is conveyed to a third conveying position (step St7). The third conveying position is a position where a part of the region Rp2 of the body portion Wb is disposed below the color head 23. When the second platen P2 is not conveyed to the third conveying position (No in step St7), the conveying continues.

On the other hand, when the second platen P2 is conveyed to the third conveying position (Yes in step St7), the second control device 50 starts processing S3 (step St8). Processing S3 includes pass processing of ejecting color ink droplets from the color head 23 to the region Rp2 of the body portion Wb while moving the color head 23 in the moving direction Dx, and conveying processing of conveying the body portion Wb in the conveying direction Dy. Processing S3 corresponds to third processing of the present disclosure.

Here, the second control device 50 executes processing S2 and processing S3 such that a higher one of the print resolution in the conveying direction Dy in processing S2 and the print resolution in the conveying direction Dy in processing S3 is an integral multiple of a lower one. For example, as shown in FIG. 9, the print resolution in processing S3 is 1200 dpi. In this case, based on the information on the nozzles to be used included in the print data, the second control device 50 reduces the number of nozzles to be used during printing corresponding to the lower print resolution by thinning out the nozzles at a prescribed interval in the moving direction Dx relative to the number of nozzles to be used during printing corresponding to the higher print resolution.

Then, the second control device 50 determines whether processing S0 to S3 are completed (step St9). When processing S0 to S3 are not completed (No in step St9), the second control device 50 continues processing S0 to S3, and when processing S0 to S3 are completed (Yes in step St9), the second control device 50 completes the printing process.

In the example of FIG. 8, for example, when an interval between a nozzle located at an upstream end of the base head 21 in the direction Dy2 and a nozzle located at a downstream end of the color head 23 in the direction Dy2 is larger than an interval between a downstream end of the region Rp2 of the body portion Wb in the direction Dy2 and an upstream end of the region Rp1 of the neck portion Wn in the direction Dy2, at least a part of processing S2 may be executed during execution of processing S1.

In the example of FIG. 8, for example, when an interval between a nozzle located at a downstream end of the base head 21 in the direction Dy2 and a nozzle located at an upstream end of the color head 23 in the direction Dy2 is smaller than an interval between an upstream end of the region Rp1 of the neck portion Wn in the direction Dy2 and a downstream end of the region Rp1 of the neck portion Wn in the direction Dy2, processing S1 may be executed during execution of processing S0.

In the example of FIG. 8, for example, when the interval between the nozzle located at the downstream end of the base head 21 in the direction Dy2 and the nozzle located at the upstream end of the color head 23 in the direction Dy2 is smaller than an interval between an upstream end of the region Rp2 of the body portion Wb in the direction Dy2 and the downstream end of the region Rp2 of the body portion Wb in the direction Dy2, processing S3 may be executed during execution of processing S2.

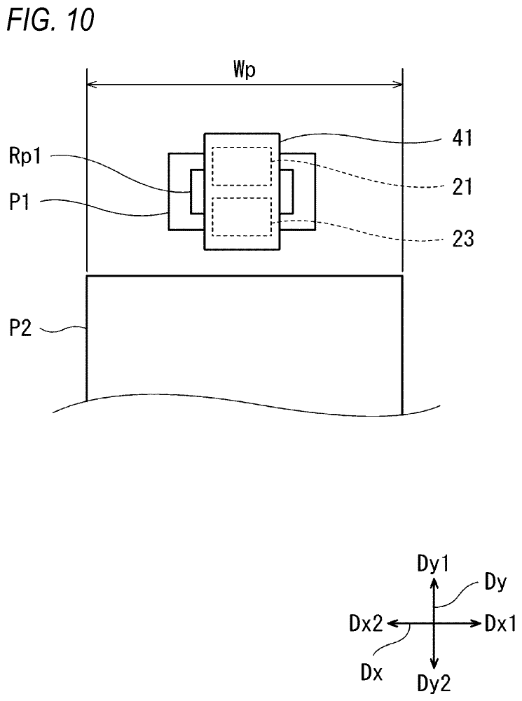

FIG. 10 shows a moving range of the carriage 41 during execution of ejection processing to the neck portion Wn. As shown in FIG. 10, the second control device 50 moves the carriage 41 in the moving direction Dx within a range smaller than a width Wp, which is a dimension of the second platen P2 supporting the body portion Wb in the moving direction Dx, when executing the ejection processing to the neck portion Wn in processing S1. The second control device 50 may move the carriage 41 in the moving direction Dx within a range smaller than the width Wp even when executing processing S0.

In the present embodiment, the second control device 50 executes processing S1, processing S2, and processing S3 without executing the wiping processing between processing S1 and processing S2 or between processing S2 and processing S3. That is, the second control device 50 does not execute the wiping processing until processing S1 is started and processing S3 is completed. The wiper 47a may execute the wiping processing after processing S3 is completed.

Next, modifications of the execution timing of the printing process shown in FIG. 8 will be described. FIG. 11A shows a modification of execution timing of the printing process of the printing device 101, and FIG. 11B shows another modification of execution timing of the printing process of the printing device 101.

The printing process shown in FIG. 11A is basically the same as the printing process in FIG. 8 described above except that processing S1 is executed after completion of processing S0 and after starting of processing S2 and processing S2 is started simultaneously with the completion of processing S0. That is, also in FIG. 11A, a part of processing S2 is executed during the execution of processing S1 as in FIG. 8.

In the example of FIG. 11A, when the interval between the nozzle located at the downstream end of the base head 21 in the direction Dy2 and the nozzle located at the upstream end of the color head 23 in the direction Dy2 is larger than the interval between the upstream end of the region Rp1 of the neck portion Wn in the direction Dy2 and the downstream end of the region Rp1 of the neck portion Wn in the direction Dy2, processing S1 is executed after the completion of processing S0.

In the example of FIG. 11A, for example, when the interval between the upstream end of the region Rp1 of the neck portion Wn in the direction Dy2 and the downstream end of the region Rp1 of the neck portion Wn in the direction Dy2 is smaller than the same interval in the example of FIG. 7 and the interval between the upstream end of the region Rp2 of the body portion Wb in the direction Dy2 and the downstream end of the region Rp2 of the body portion Wb in the direction Dy2 is larger than the same interval in the example of FIG. 7, processing S1 is executed after starting of processing S2.

In the example of FIG. 11A, for example, when an interval between the nozzle located at the upstream end of the base head 21 in the direction Dy2 and the nozzle located at the downstream end of the base head 21 in the direction Dy2 is equal to or larger than the interval between the downstream end of the region Rp2 of the body portion Wb in the direction Dy2 and the upstream end of the region Rp1 of the neck portion Wn in the direction Dy2, processing S2 is started simultaneously with the completion of processing S0.

The printing process shown in FIG. 11B is basically the same as the printing process in FIG. 8 described above except that processing S1 is started simultaneously with the completion of processing S0. That is, also in FIG. 11B, a part of processing S2 is executed during the execution of processing S1 as in FIG. 8.

In the example of FIG. 11A, when the interval between the nozzle located at the downstream end of the base head 21 in the direction Dy2 and the nozzle located at the upstream end of the color head 23 in the direction Dy2 is equal to or smaller than the interval between the upstream end of the region Rp1 of the neck portion Wn in the direction Dy2 and the downstream end of the region Rp1 of the neck portion Wn in the direction Dy2, processing S1 is executed simultaneously with the completion of processing S0.

According to the present embodiment as described above, since at least a part of processing S2 is executed during the execution of processing S1, printing time can be shortened as compared with a case where processing S2 is executed after the execution of processing S1.

Further, in the present embodiment, since the wiping processing is not executed between processing S1 and processing S2 or between processing S2 and processing S3, time until processing S1, processing S2, and processing S3 are completed can be shortened as compared with a case where the wiping processing is executed at least between the processing 1 and processing S2 and between processing S2 and processing S3.

Further, in the present embodiment, processing S1 and processing S2 are executed such that a higher one of the print resolution in the conveying direction Dy in processing S1 and the print resolution in the conveying direction Dy in processing S2 is an integral multiple of a lower one. For this reason, it is possible to avoid a situation in which the higher print resolution is not an integral multiple of the lower print resolution, that is, a situation in which at least a part of processing S2 cannot be executed during the execution of processing S1. Therefore, printing time of processing S1 and S2 can be shortened as compared with a case where a higher print resolution is not an integral multiple of a lower print resolution.

Further, in the present embodiment, processing S2 and processing S3 are executed such that a higher one of the print resolution in the conveying direction Dy in processing S1 and the print resolution in the conveying direction Dy in processing S2 is an integral multiple of a lower one. For this reason, it is possible to avoid a situation in which the higher print resolution is not an integral multiple of the lower print resolution, that is, a situation in which a part of processing S3 cannot be executed during the execution of processing S2. Therefore, printing time of processing S2 and S3 can be shortened as compared with a case where a higher print resolution is not an integral multiple of a lower print resolution.

In addition, in the present embodiment, since the height of the support surface Ss1 of the first platen P1 and the height of the support surface Ss2 of the second platen P2 are the same, compared to a case where the support surface Ss1 and the support surface Ss2 are not of the same height, landing accuracy of ink is improved, and thus deterioration of image quality can be restricted.

In the present embodiment, the carriage 41 is moved in a range smaller than the width that is the dimension of the second platen P2 in the moving direction Dx during the execution of processing S1. Accordingly, processing time of processing S1 can be shortened as compared with a case where the carriage 41 moves in a range larger than the width of the second platen P2 during the execution of processing S1.

Further, in the present embodiment, the image processing device 102 creates the first part print data corresponding to the neck portion Wn and the second part print data corresponding to the body portion Wb, and creates print data obtained by integrating the first part print data and the second part print data at a higher image resolution. In this manner, since the first part print data and the second part print data have the same image resolution at the higher image resolution, it is possible to avoid a situation that would occur when the first part print data and the second part print data do not have the same image resolution, that is, a situation in which at least a part of processing S2 cannot be executed during the execution of processing S1. Therefore, the printing time of processing S1 and S2 can be shortened as compared with a case where the first part print data and the second part print data do not have the same image resolution.

The present disclosure is not limited to the above-described embodiment, and following modifications can be adopted without departing from the gist of the present disclosure.

In FIG. 7, a part of processing S2 is executed during the execution of processing S1. Alternatively, the present disclosure is not limited thereto, and the entire processing S2 may be executed during the execution of processing S1.

In the above embodiment, the second control device 50 executes processing S1, processing S2, and processing S3 without executing the wiping processing between processing S1 and processing S2 or between processing S2 and processing S3. Alternatively, the present disclosure is not limited thereto. The second control device 50 may execute the wiping processing between processing S1 and processing S2 and between processing S2 and processing S3.

In the above-described embodiment, the first platen P1 supports the neck portion Wn, and the second platen P2 supports the body portion Wb. Alternatively, the present disclosure is not limited thereto. The first platen P1 may support the body portion Wb, and the second platen P2 may support the neck portion Wn.

In the above-described embodiment, a mode in which printing is executed from the neck portion Wn before the body portion Wb is exemplified. Alternatively, the present disclosure is not limited thereto. The printing may be executed from the body portion Wb before the neck portion Wn. In this case, at least a part of processing of ejecting ink droplets of base ink to the neck portion Wn is executed during execution of processing of ejecting ink droplets of color ink to the body portion Wb. In this mode, in FIG. 1 described above, for example, the base head 21 and the color head 23 are disposed opposite to each other in the conveying direction Dy, and the first platen P1 and the second platen P2 are conveyed in the direction Dy1 during printing.

In the above embodiment, the nozzle surface NM1 is wiped by the wiper 47a of the wiper device 47, and the nozzle surface NM3 is wiped by the wiper 147a of the wiper device 147. Alternatively, the present disclosure is not limited thereto. Only the nozzle surface NM1 may be wiped by the wiper 47a, or only the nozzle surface NM3 may be wiped by the wiper 147a. Alternatively, both the nozzle surface NM1 and the nozzle surface NM3 may be wiped by one wiper.

In the above-described embodiment, the carriage 41 that supports two heads including the base head 21 and the color head 23 is exemplified. Alternatively, the two heads may not be supported by one carriage 41. For example, carriages corresponding to respective heads may be provided. In this case, in a mode in which the carriage 41 that supports the base head 21 and the color head 23 is provided, the print resolution in the moving direction Dx in processing S1 and the print resolution in the moving direction Dx in processing S2 may not be necessarily the same. That is, when the higher one of the print resolution in the moving direction Dx in processing S1 and the print resolution in the moving direction Dx in processing S2 is an integral multiple of the lower one, at least a part of processing S2 may be executed during the execution of processing S1. On the other hand, in a mode in which two carriages respectively corresponding to the base head 21 and the color head 23 are provided, the print resolution in the moving direction Dx in processing S1 and the print resolution in the moving direction Dx in processing S2 may not be the same, or the higher one of the print resolution in the moving direction Dx in processing S1 and the print resolution in the moving direction Dx in processing S2 may not be an integral multiple of the lower one thereof.

In the above-described embodiment, the base head 21 and the color head 23, which are serial heads, are used. Alternatively, the present disclosure is not limited thereto. A line head extending in the moving direction Dx may be used in the printing device 101. In this case, the T-shirt Wt is conveyed in the conveying direction Dy while being supported by a platen.

In the above-described embodiment, the second control device 50 moves the carriage 41 in the moving direction Dx in a range smaller than the width Wp of the second platen P2 when executing processing S1. Alternatively, the present disclosure is not limited thereto. The second control device 50 may move the carriage 41 in the moving direction Dx in a range larger than the width Wp of the second platen P2 when executing processing S1.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A printing device comprising:
a color head configured to eject a color ink;
a base head configured to eject a base ink;
a first platen configured to support a first portion, the first portion being one of a neck portion and a body portion located apart from the neck portion provided on a print medium;
a second platen configured to support a second portion, the second portion being the other one of the neck portion and the body portion; and
a control device, wherein
the control device is configured to execute
first processing of ejecting the color ink from the color head to the first portion supported by the first platen,
second processing of ejecting the base ink from the base head to the second portion supported by the second platen, and
third processing of ejecting the color ink from the color head to the second portion supported by the second platen, and
at least a part of the second processing is executed during execution of the first processing.

2. The printing device according to claim 1, wherein
the color head has a first nozzle surface,
the base head has a second nozzle surface,
the printing device further comprises a wiper device configured to execute wiping processing of wiping at least one of the first nozzle surface and the second nozzle surface, and
the control device is configured to execute the first processing, the second processing, and the third processing without executing the wiping processing between the first processing and the second processing or between the second processing and the third processing.

3. The printing device according to claim 1, wherein
the first platen and the second platen are configured to convey the print medium in a conveying direction, and
the control device is configured to execute the first processing and the second processing such that a higher resolution of a resolution in the conveying direction in the first processing and a resolution in the conveying direction in the second processing is an integral multiple of a lower resolution thereof.

4. The printing device according to claim 3, wherein
the control device is configured to execute the second processing and the third processing such that a higher resolution of the resolution in the conveying direction in the second processing and a resolution in the conveying direction in the third processing is an integral multiple of a lower resolution thereof.

5. The printing device according to claim 1, wherein
the first platen has a first support surface configured to support the first portion,
the second platen has a second support surface configured to support the second portion, and
the first support surface has a height that is the same as a height of the second support surface.

6. The printing device according to claim 1, further comprising:
a carriage configured to support the color head and the base head and move in a prescribed moving direction, wherein
the control device is configured to move the carriage in a range smaller than a width that is a dimension in the moving direction of a platen which supports the body portion of the first platen and the second platen during execution of the ejection processing to the neck portion in the first processing, the second processing, and the third processing.

7. A printing method for executing printing on a neck portion and a body portion located apart from the neck portion provided on a print medium, the printing method comprising:
ejecting color ink from a color head to a first portion that is one of the neck portion and the body portion in first processing;
ejecting base ink from a base head to a second portion that is the other one of the neck portion and the body portion in second processing; and
ejecting the color ink from the color head to the second portion in third processing, wherein
at least a part of the second processing is executed during execution of the first processing.

8. A non-transitory computer-readable storage medium storing a printing program to be executed by a computer in a printing device including a color head, a base head, and the computer, the printing device being configured to execute printing on a neck portion and a body portion located apart from the neck portion provided on a print medium, the printing program causing the computer to execute:
a step of ejecting color ink from the color head to a first portion that is one of the neck portion and the body portion in first processing;
a step of ejecting base ink from the base head to a second portion that is the other one of the neck portion and the body portion in second processing; and
a step of ejecting the color ink from the color head to the second portion in third processing, wherein
at least a part of the second processing is executed during execution of the first processing.

9. A printing system comprising:
a print data generator configured to create print data; and
the printing device according to claim 1 configured to execute printing based on the print data, wherein
the print data generator is configured to create the print data by integrating first part print data for executing printing on the neck portion at a first resolution and second part print data for executing printing on the body portion at a second resolution different from the first resolution at a higher resolution of the first resolution and the second resolution.
